(19) United States
(12) Patent Application Publication
(10) Pub. No.: US 2026/0136418 A1
(43) Pub. Date: May 14, 2026

(54) GROUP ADDRESSED BUFFERABLE UNITS (BUS) INDICATION IN TRAFFIC INDICATION MAP (TIM) FOR MULTI-LINK OPERATION

(71) Applicant: Intel Corporation, Santa Clara, CA (US)

(72) Inventors: Laurent Cariou, Milizac (FR); Po-Kai Huang, San Ramon, CA (US)

(73) Assignee: Intel Corporation, Santa Clara, CA (US)

(21) Appl. No.: 19/367,530

(22) Filed: Oct. 23, 2025

Related U.S. Application Data
(63) Continuation of application No. 17/645,441, filed on Dec. 21, 2021.

(51) Int. Cl. H04W 76/15; H04W 8/26

(52) U.S. Cl. CPC H04W 76/15; H04W 8/26

(57) ABSTRACT

This disclosure describes systems, methods, and devices related to group addressed BUs. A device may encode a traffic indication map (TIM) element with information associated with a plurality of access points (APs) in a multiple basic service set identifications (BSSIDs) set and one or more APs of the AP MLD. The device may cause to send a beacon frame comprising the TIM element to one or more station devices (STAs).

### CROSS-REFERENCE TO RELATED PATENT APPLICATION(S)

This application is a continuation of U.S. Non-Provisional application Ser. No. 17/645,441, filed Dec. 21, 2021, the disclosure of which is incorporated by reference as set forth in full.

### TECHNICAL FIELD

This disclosure generally relates to systems and methods for wireless communications and, more particularly, to group addressed bufferable units (BUs) indication in traffic indication map (TIM) for multi-link operation.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for group addressed bufferable units (BUs), in accordance with one or more example embodiments of the present disclosure.

FIG. 2 depicts an illustrative schematic diagram for a multi-link device (MLD) between two logical entities, in accordance with one or more example embodiments of the present disclosure.

FIG. 3 depicts an illustrative schematic diagram for an MLD between AP with logical entities and a non-AP with logical entities, in accordance with one or more example embodiments of the present disclosure.

FIG. 4 depicts an illustrative schematic diagram for a number of bits in a partial virtual bitmap field that is included in a TIM element of the beacon frame.

FIG. 5 depicts an illustrative schematic diagram for group addressed BUs, in accordance with one or more example embodiments of the present disclosure.

FIG. 6 depicts an illustrative schematic diagram for group addressed BUs, in accordance with one or more example embodiments of the present disclosure.

FIG. 7 depicts an illustrative schematic diagram for group addressed BUs, in accordance with one or more example embodiments of the present disclosure.

FIG. 8 depicts an illustrative schematic diagram for group addressed BUs, in accordance with one or more example embodiments of the present disclosure.

FIG. 9 illustrates a flow diagram of a process for an illustrative group addressed BUs system, in accordance with one or more example embodiments of the present disclosure.

FIG. 10 illustrates a functional diagram of an exemplary communication station that may be suitable for use as a user device, in accordance with one or more example embodiments of the present disclosure.

FIG. 11 illustrates a block diagram of an example machine upon which any of one or more techniques (e.g., methods) may be performed, in accordance with one or more example embodiments of the present disclosure.

FIG. 12 is a block diagram of a radio architecture in accordance with some examples.

FIG. 13 illustrates an example front-end module circuitry for use in the radio architecture of FIG. 12, in accordance with one or more example embodiments of the present disclosure.

FIG. 14 illustrates an example radio IC circuitry for use in the radio architecture of FIG. 12, in accordance with one or more example embodiments of the present disclosure.

FIG. 15 illustrates an example baseband processing circuitry for use in the radio architecture of FIG. 12, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

There is to define ways for a non-AP station device (STA) to discover an AP multi-link device (MLD). As the AP MLD is made of multiple APs operating on different bands, each AP of the AP MLD will be sending a beacon frame that includes:
A description of its capabilities, operation elements.
A basic description of the other AP of the same MLD that are collocated: can be a report in a Reduced Neighbor Report element.

In some rare cases, the description of the other APs could be complete and include all the capabilities, operation elements of the other APs.

An AP includes in the TIM element in the beacon frames it transmits at delivery traffic indication map (DTIM) (DTIM beacons) an indication of whether the AP has buffered group-addressed frames (that it will deliver right after the DTIM beacon frame transmission). That indication is carried for a regular AP (with dot11MultiBSSIDImplemented set to 0) by using the traffic indicator field in the bitmap control first in the TIM element). For example, an AID may be assigned to an STA, where if AID has a bit value of 1 would indicate that the AP has data to be sent to the STA at a later time. Similarly, an AID may have a bit value set to indicate whether group addressed frames (bufferable units (BUs)). For example, AID0 (first AID in the bitmap) may be set to 1 if the AP has group addressed frames/BUs for a group of STAs. So these STAs would have to wake up at a certain time to receive these group addressed BUs. The AP would broadcast group addressed frames to these STAs.

If the AP implements a multiple BSSID (e.g., dot11 MultiBSSIDImplemented set to 1), that means that there are a plurality of BSSIDs operating on the same channel/link. In the beacon frame, the transmitted BSSID AP may include a multiple BSSID element that carries the information of all other APs in the multiple BSSID set. The TIM element will include information for all STAs associated with the transmitted BSSID AP and all the other STAs associated with the other APs in the multiple BSSID set (referred to as non-transmitted APs). Example embodiments of the present disclosure relate to systems, methods, and devices for details for group addressed BUs indication in TIM for Multi-Link operation.

In one or more embodiments, cases that need to be covered include 1) where there are multiple APs in a multiple BSSID set but no AP MLD, 2) when there is an AP MLD but no multiple BSSID set, and 3) when there are both AP and MLDs and multiple APs in a multiple BSSID set.

When dot11MultiBSSIDImplemented=0 (e.g., no multiple BSSID set), a group addressed BUs system may assign some bits in the partial virtual bitmap field in the TIM element in order to indicate that one or more group addressed frames are buffered for each AP corresponding to an AP of the AP MLD of the AP sending the frame carrying the TIM element, and these bits are called something like BSSofAPMLD identifiers.

When dot11MultiBSSIDImplemented=1 (use of multiple BSSID set), a group addressed BUs system may assign, for the transmitted BSSID and for each of the non-transmitted BSSIDs, some bits in the partial virtual bitmap field in the TIM element in order to indicate that one or more group addressed frames are buffered for each AP corresponding to an AP of the AP MLD to which the transmitted BSSID or a nontransmitted BSSID is affiliated to, and these bits are called something like BSSofAPMLD for the AP MLD of the transmitted BSSID and BSSofAPMLDofNonTxBSS identifiers for the AP MLD of the nontransmitted BSSID.

In one or more embodiments, in order to preserve backward compatibility, these sets of bits may be using a higher index than the ones used by the NonTxBSS identifiers (1 to 2ⁿ⁻¹).

In one or more embodiments, these BSSofAPMLD bits can be ordered in the order of multiple BSSID index: BSSofAPMLD of transmitted BSSID first, followed by BSSofAPMLDofNonTxBSS of nontransmitted BSSID with BSSID Index 1, followed by BSSofAPMLDofNonTxBSS of nontransmitted BSSID with BSSID Index 2.

In one or more embodiments, these BSSofAPMLD bits can be ordered in the order of links: first bit of BSSofAPMLD (corresponding to link2 of transmitted BSSID first, followed by first bit of BSSofAPMLDofNonTxBSS (corresponding to link2) of nontransmitted BSSID with BSSID Index 1), followed by first bit of BSSofAPMLDofNonTxBSS (corresponding to link2) of nontransmitted BSSID with BSSID Index 2), etc. The second bit of BSSofAPMLD (corresponding to link3 of transmitted BSSID) first, followed by second bit of BSSofAPMLDofNonTxBSS (corresponding to link3) of nontransmitted BSSID with BSSID Index 1), followed by second bit of BSSofAPMLDofNonTxBSS (corresponding to link3) of nontransmitted BSSID with BSSID Index 2).

In one or more embodiments, these for simplicity, the size of BSSofAPMLD and of BSSofAPMLDofNonTxBSS may be the same, even if the number of APs in each AP MLD is different, and even if a nonTxBSSID is not part of an MLD. In this case, bits that correspond to an AP that does not exist are set to 0 and ignored. Alternatively, the size of BSSofAPMLD and of BSSofAPMLDofNonTxBSS can be different and either signaled explicitly in the frame or implicitly derived from other indications in the beacon frame (reduced neighbor report).

In one or more embodiments, a group addressed BUs system may facilitate that the AP can send a frame at any time (but especially when it sets the end of service period (EOSP) bit to 1 for a group-address frame to indicate that the group address delivery period after DTIM is over, providing an indication of the buffered group-address frames in other APs of the same AP MLD as the AP sending the frame. In that case, there is no need to consider the multiple BSSID case, and simply need to provide a bitmap for the other APs of the AP MLD.

In one or more embodiments, a group addressed BUs system may facilitate that any signaling can work. As an example, to use a generic A-control field (in HT control field in the MAC header of a frame), which is made of a link bitmap field and a type field, and with the type field set to a value corresponding to “indication of group-addressed frames buffered at the AP with index in the link bitmap”. In that case, each AP of the AP MLD has a bit in the link bitmap that corresponds to it, and that bit is set to 1 if that AP has buffered group-addressed frames, and is set to 0 otherwise.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

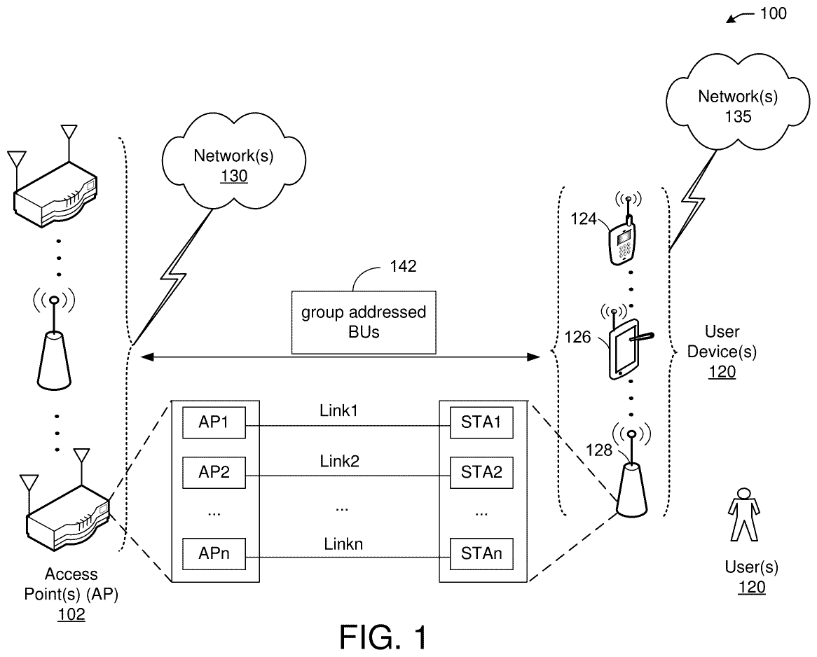

FIG. 1 is a network diagram illustrating an example network environment of group addressed BUs, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

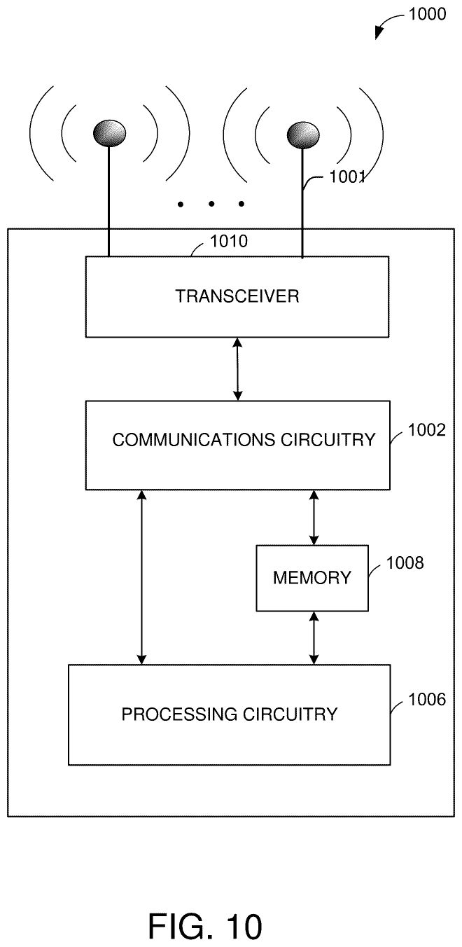

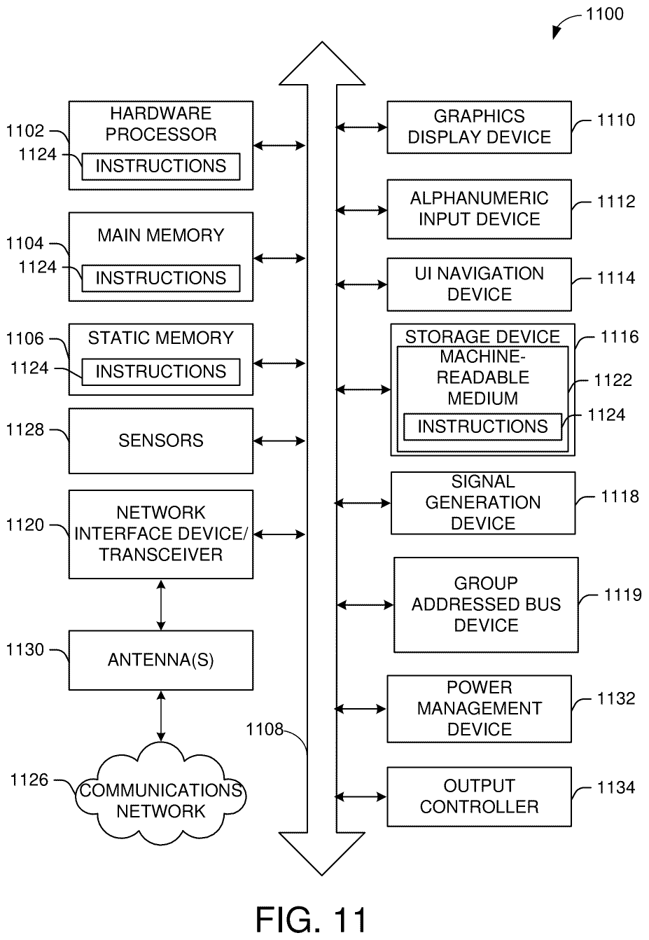

In some embodiments, the user devices 120 and the AP 102 may include one or more computer systems similar to that of the functional diagram of FIG. 10 and/or the example machine/system of FIG. 11.

One or more illustrative user device(s) 120 and/or AP(s) 102 may be operable by one or more user(s) 110. It should be noted that any addressable unit may be a station (STA). An STA may take on multiple distinct characteristics, each of which shapes its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11 g, 802.11n, 802.11ax), 5 GHz channels (e.g., 802.11n, 802.11ac, 802.11ax, 802.11be, etc.), 6 GHz channels (e.g., 802.11ax, 802.11be, etc.), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a group addressed BUs 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for purposes of illustration and are not meant to be limiting.

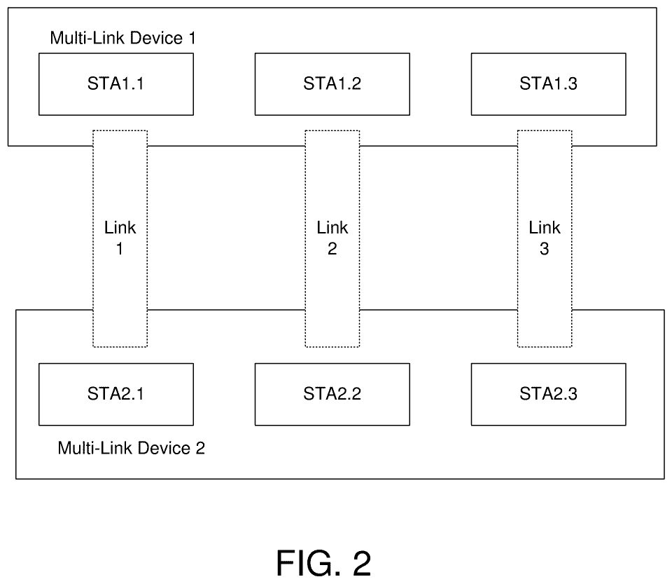

FIG. 2 depicts an illustrative schematic diagram for two multi-link devices (MLDs), in accordance with one or more example embodiments of the present disclosure.

Referring to FIG. 2, there are shown two MLDs, where each MLD includes multiple STAs that can set up links with each other. An MLD may be a logical entity that contains one or more STAs. The MLD has one MAC data service interface and primitives to the logical link control (LLC) and a single address associated with the interface, which can be used to communicate on the distribution system medium (DSM). It should be noted that an MLD allows STAs within the MLD to have the same MAC address. It should also be noted that the exact name can be changed.

In this example of FIG. 2, the MLD 1 and MLD 2 may be two separate physical devices, where each one comprises a number of virtual or logical devices. For example, MLD 1 may comprise three STAs, STA1.1, STA1.2, and STA1.3 and MLD 2 that may comprise three STAs, STA2.1, STA2.2, and STA2.3. The example shows that logical device STA1.1 is communicating with logical device STA2.1 over link 1, that logical device STA1.2 is communicating with logical device STA2.2 over link 2, and that device STA1.3 is communicating with logical device STA2.3 over link 3.

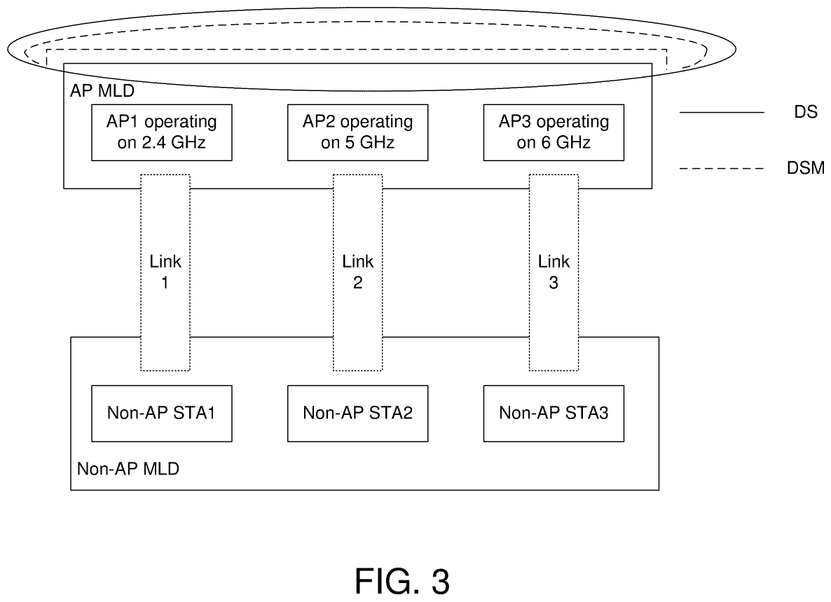

FIG. 3 depicts an illustrative schematic diagram for an AP MLD and a non-AP MLD, in accordance with one or more example embodiments of the present disclosure.

Referring to FIG. 3, there are shown two MLDs on either side which includes multiple STAs that can set up links with each other. For infrastructure framework, the AP MLD may include APs (e.g., AP1, AP2, and AP3) on one side, and the non-AP MLD may include non-AP STAs (STA1, STA2, and STA3) on the other side. The detailed definition is shown below. AP MLD is a multi-link logical entity, where each STA within the MLD is an EHT AP. Non-AP MLD is a multi-link logical entity, where each STA within the multi-link logical entity is a non-AP EHT STA. It should be noted that this framework is a natural extension from the one link operation between two STAs, which are AP and non-AP STA under the infrastructure framework (e.g., when an AP is used as a medium for communication between STAs).

In the example of FIG. 3, the AP MLD and non-AP MLD may be two separate physical devices, where each one comprises a number of virtual or logical devices. For example, the AP MLD may comprise three APs, AP1 operating on 2.4 GHZ, AP2 operating on 5 GHZ, and AP3 operating on 6 GHz. Further, the non-AP MLD may comprise three non-AP STAs, STA1 communicating with AP1 on link 1, STA2 communicating with AP2 on link 2, and STA3 communicating with AP3 on link 3. It should be understood that these are only examples and that more or less entities may be included an MLD.

The AP MLD is shown in FIG. 3 to have access to a distribution system (DS), which is a system used to interconnect a set of BSSs to create an extended service set (ESS). The AP MLD is also shown in FIG. 3 to have access a distribution system medium (DSM), which is the medium used by a DS for BSS interconnections. Simply put, DS and DSM allow the AP MLD to communicate with different BSSs.

It should be understood that although the example shows three logical entities within the AP MLD and the three logical entities within the non-AP MLD, this is merely for illustration purposes and that other numbers of logical entities with each of the AP MLD and non-AP MLD may be envisioned.

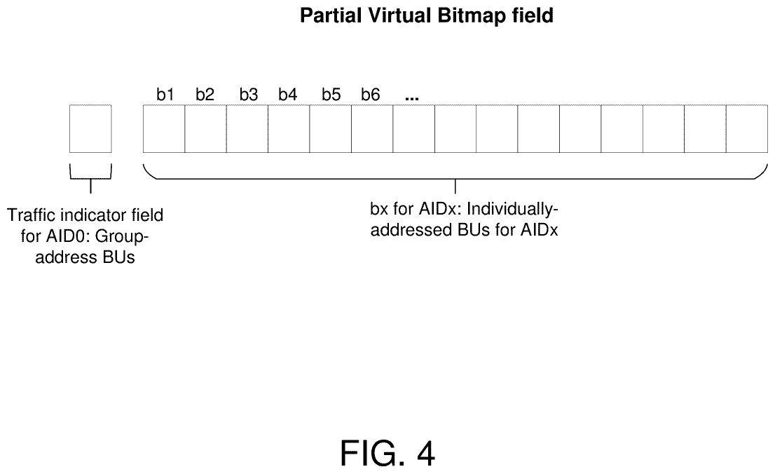

FIG. 4 depicts an illustrative schematic diagram for a number of bits in a partial virtual bitmap field that is included in a TIM element of the beacon frame.

In one or more embodiments, a group addressed BUs system may designate or assign an AP with a “transmitted BSSID” when the AP is responsible for transmitting one beacon frame on behalf of the other APs in a multiple BSSID set. The BSSID of the AP belonging to a multiple BSSID set is referred to as the transmitted BSSID if the AP includes the Multiple BSSID element in the Beacon frame that it transmits.

In one or more embodiments, in a multiple BSSID set, there may not be more than one AP corresponding to the transmitted BSSID. The BSSID of an AP belonging to a multiple BSSID set is a nontransmitted BSSID for an AP that is not designated with the transmitted BSSID. Among all AP STAs in multiple BSSID set, only the AP corresponding to the transmitted BSSID may transmit a beacon frame.

Currently, an AP includes in the TIM element in the beacon frames it transmits at DTIM (DTIM beacons) an indication whether the AP has buffered group-addressed frames (that it will deliver right after the DTIM beacon frame transmission). That indication is carried for a regular AP (with dot11MultiBSSIDImplemented set to 0 by using the Traffic Indicator field in the Bitmap Control first in the TIM element).

Referring to FIG. 4, there is shown a number of bits in a partial virtual bitmap field that is included in a TIM element of the beacon frame. Each of these bits are for AIDs assigned to APs and/or STAs. For example, AID0 may be assigned to the AP sending the beacon frame. In the scenario where dot11 MultiBSSIDImplemented is set to 0 and the traffic indicator field for AID0 is set to 1 or 0 to indicate whether there are group address BUs or not, respectively. In this FIG. 4, if the indicator is set to 0, then there are no group addressed BUs but instead there may only be individually addressed BUs to each of the AIDs. For example, bit x for AIDx may be set to 1 to indicated that a device (e.g., a STAx) has individually addressed BUs for it to receive (x is a positive integer). It is understood that the above descriptions are for purposes of illustration and are not meant to be limiting.

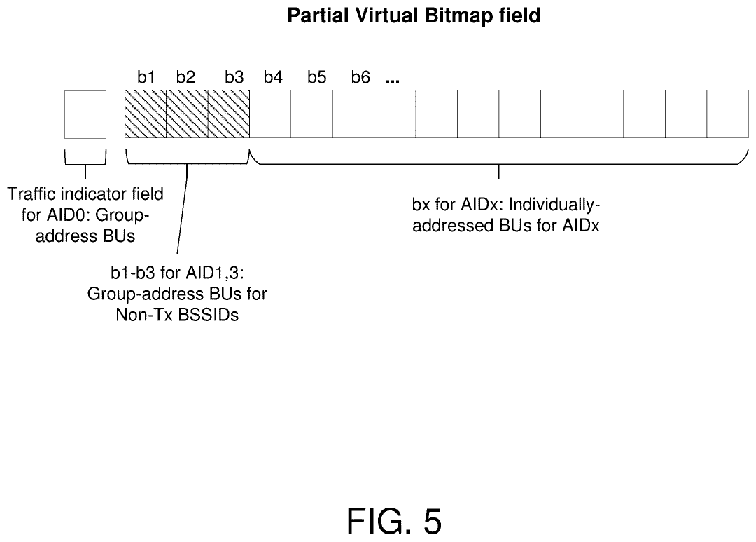

FIG. 5 depicts an illustrative schematic diagram for group addressed BUs, in accordance with one or more example embodiments of the present disclosure.

For an AP with dot11MultiBSSIDImplemented set to 1, the traffic indicator field in the bitmap control first in the TIM element carries the indication for the transmitted BSSID (the AP sending the beacon), and the first 2ⁿ⁻¹ bits of the partial virtual bitmap field are used to indicate that one or more group addressed frames are buffered for each AP corresponding to a nontransmitted BSSID and are called NonTxBSS identifiers.

Referring to FIG. 5, there is shown a number of bits in a partial virtual bitmap field that is included in a TIM element of the beacon frame. Each of these bits are for AIDs assigned to APs and/or STAs. For example, AID0 may be assigned to the AP sending the beacon frame. In the scenario where dot11MultiBSSIDImplemented is set to 1 and the traffic indicator field for AID0 is set to 1 or 0 to indicate whether there are group address BUs or not, respectively. In this FIG. 5, if the indicator is set to 1, then there are group addressed BUs. In that case bits b1, b2, and b3 for AIDs 1, 2, and 3, respectively, are set to 1 or 0 to indicate to the STAs associated with non-transmitted BSSID APs that there are group addressed BUs for them or not, respectively. For example, if bit b1 is set to 1, that means the STAs that are associated with the non-transmitted BSSID AP that is assigned AID1 will have group addressed BUs that the STAs have to wake up and receive at a later time. Further to the bits that are set for the group addressed BUs, there is another set of bits that is assigned for other AIDs for individually addressed BUs. For example, bit b6 in the example of FIG. 5, may be assigned to AID6 for an STA. If the bit b6 is set to 1, that means that there are individually addressed BUs for the STA and that STA would have to wake up at a later time to receive these individually addressed BUs.

It is understood that the above descriptions are for purposes of illustration and are not meant to be limiting.

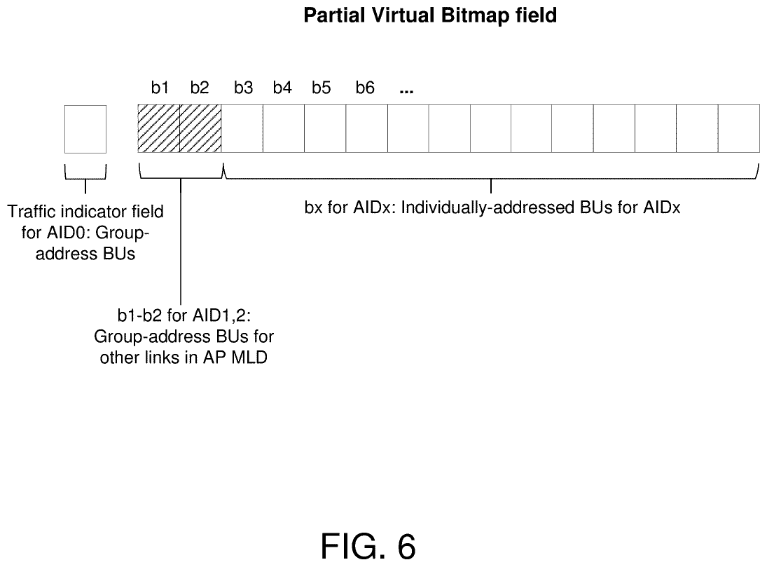

FIG. 6 depicts an illustrative schematic diagram for group addressed BUs, in accordance with one or more example embodiments of the present disclosure.

FIG. 6, shows an example of bit assignment for partial virtual bitmap field in TIM element when dot11MultiBSSIDImplemented=0 (no multiple BSSID set).

In one or more embodiments, if an AP is part of an AP MLD, a group addressed BUs system may facilitate that the AP can include in its beacon frame an indication that other APs of the same AP MLD have buffered group-addressed BUs. For example, if an AP MLD has three APs (AP1, AP2, and AP3), then at least one of these three APs will need to include in its beacon frames an indication about the other APs whether there are group addressed BUs for STAs that are associated with those APs.

This may need to work when dot11MultiBSSIDImplemented=0 and when dot11MultiBSSIDImplemented=1 (when each nontransmitted BSSID can be part of an AP MLD and therefore provide an indication for the APs in the same AP MLD as the nontransmitted BSSIDs as well).

Referring to FIG. 6, there is shown a number of bits in a partial virtual bitmap field that is included in a TIM element of the beacon frame. Each of these bits is for AIDs assigned to APs and/or STAs. For example, AID0 may be assigned to the AP sending the beacon frame. In the scenario where dot11MultiBSSIDImplemented is set to 0 and the traffic indicator field for AID0 is set to 1 or 0 to indicate whether there is group address BUs or not, respectively.

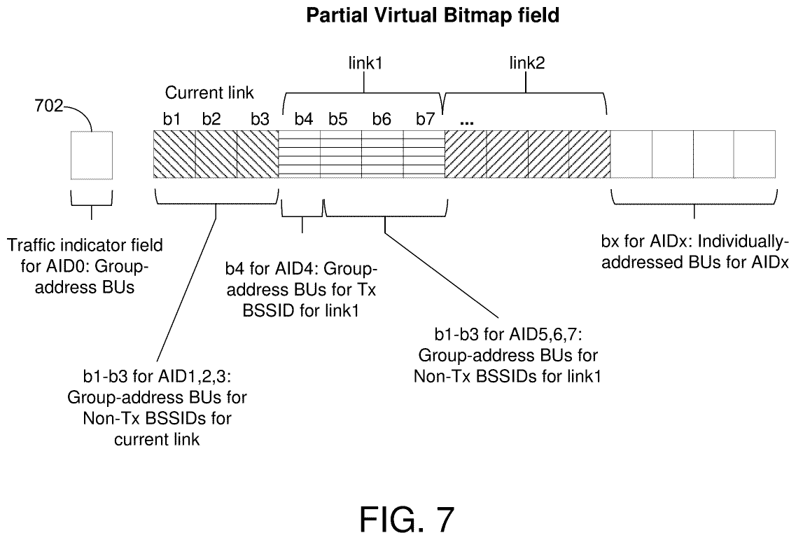

FIG. 7 depicts an illustrative schematic diagram for group addressed BUs, in accordance with one or more example embodiments of the present disclosure.

FIG. 7 shows an example of bit assignment for Partial Virtual bitmap field in TIM element when dot11MultiBSSIDImplemented=1.

For example, field 702 shows a traffic indicator field for AID0 (e.g., the AP sending the beacon frame). A first set of bits may be assigned to AIDs for non-transmitted APs for a current link. For example, bit 1 may be assigned to AID1 for a non-transmitted AP1 of the multiple BSSID set.

It should be noted that this design does not cause legacy devices to be confused because the first set of bits is the same as in the legacy systems. That is, the first set of bits (e.g., bits b1, b2, and b3) is for APs that are in a multiple BSSID set. After that first set, it depends whether there is an AP MLD that has group addressed BUs or not.

In case an AP MLD is used, where the AP MLD comprises a plurality of APs, the next set of bits (e.g., bits b4, b5, b6, b7, etc.) after the first set of bits may be assigned to AIDs for the plurality of APs in the AP MLD. For example, bit b4 may be assigned to a first AP of the AP MLD that is designated as the transmitted BSSID AP. Bit b5, b6, b7, etc. may be assigned to indicate whether there is group addressed BUs for the non-transmitted BSSID APs of the AP MLD.

The following Table 1 shows an example of bits that may be set based on three multiple BSSID sets and three APs in an AP MLD.

TABLE 1

| | LINK 1 | LINK2 | LINK3 | |
|---|---|---|---|---|
| TXBSSID | BSS1 | BSS4 | BSS7 | AP1 of AP |
| | | | | MLD |
| Non-TX | BSS2 | BSS5 | BSS8 | AP2 of AP |
| BSSID | | | | MLD |
| Non-TX | BSS3 | BSS6 | BSS9 | AP3 of AP |
| BSSID | | | | MLD |
| | Multiple | Multiple | Multiple | |
| | BSSID Set1 | BSSID Set2 | BSSID Set3 | |

According to the embodiment of FIG. 7, for the example of Table 1, the order of the bits in the partial virtual bitmap field would be BSS1, BSS2, BSS3, BSS4, BSS5, BSS6, BSS7, BSS8, and BSS9, where each BSSx indicates information associated with a group addressed BU assigned to an AP, where x is the positive integer. For example, if BSS4 at bit b4 is set to 1 that means that the AP1 of the AP MLD has group addressed BUs on link 2.

It is understood that the above descriptions are for purposes of illustration and are not meant to be limiting.

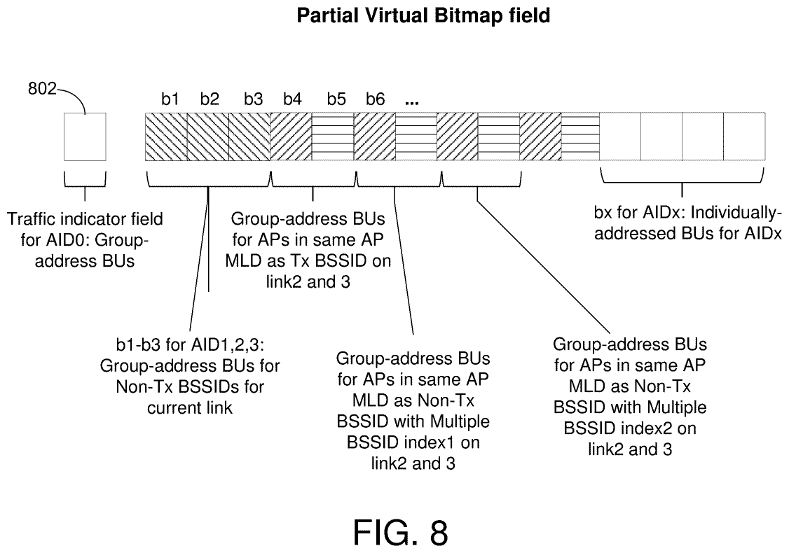

FIG. 8 depicts an illustrative schematic diagram for group addressed BUs, in accordance with one or more example embodiments of the present disclosure.

FIG. 8 shows an example of bit assignment for partial virtual bitmap field in TIM element when dot11MultiBSSIDImplemented=1.

For example, field 802 shows a traffic indicator field for AID0 (e.g., the AP sending the beacon frame). A first set of bits (e.g., bits b1, b2, and b3) may be assigned to AIDs for non-transmitted APs for a current link. For example, bit b1 may be assigned to AID1 for a non-transmitted AP1 of the multiple BSSID set.

It should be noted that this design does not cause legacy devices to be confused because the first set of bits is the same as in the legacy systems. That is, the first set of bits is for APs that are in a multiple BSSID set. After that first set, it depends whether there is an AP MLD that has group addressed BUs or not.

In case an AP MLD is used, where the AP MLD comprises a plurality of APs, the next set of bits (e.g., bits b4, b5, b6, b7, etc.) after the first set of bits may be assigned to AIDs for the plurality of APs in the AP MLD. For example, bits b4 and b5 may be assigned to indicate group addressed BUs for APs in the same AP MLD as a transmitted BSSID AP on links 2 and 3. Bits b5 and b6 may be assigned to indicate group addressed BUs for APs in the same AP MLD as non-transmitted BSSID APs with multiple BSSID index 1 on link 2 and three.

According to the embodiment of FIG. 8, for the example of Table 1, the order of the bits in the partial virtual bitmap field would be BSS1, BSS2, BSS3, BSS4, BSS7, BSS5, BSS8, BSS6, and BSS9, where each BSSx indicates information associated with a group addressed BU assigned to an AP, where x is the positive integer. For example, if BSS4 at bit b4 is set to 1 that means that the AP1 of the AP MLD has group addressed BUs on link 2.

It is understood that the above descriptions are for purposes of illustration and are not meant to be limiting.

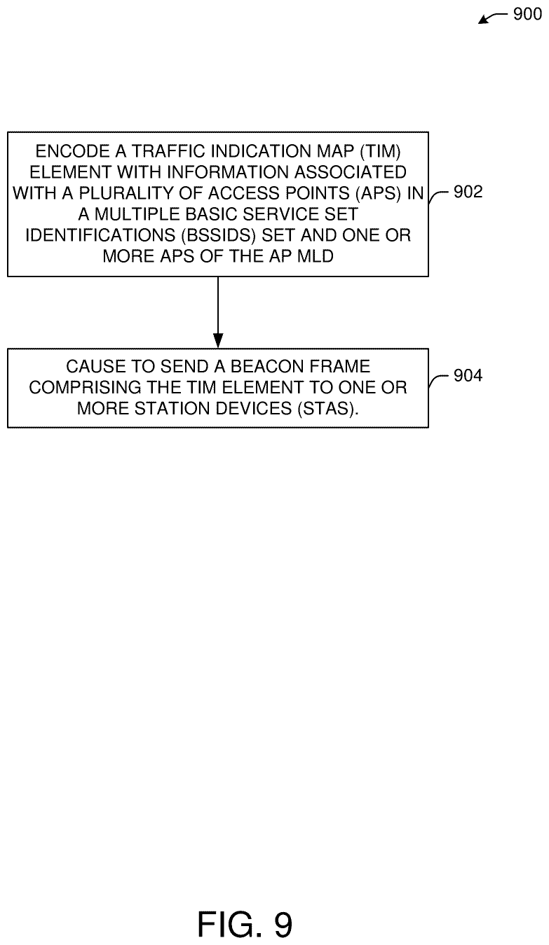

FIG. 9 illustrates a flow diagram of illustrative process 900 for a group addressed BUs system, in accordance with one or more example embodiments of the present disclosure.

At block 902, a device (e.g., the user device(s) 120 and/or the AP 102 of FIG. 1 and/or the group addressed BUs device 1119 of FIG. 11) may encode a traffic indication map (TIM) element with information associated with a plurality of access points (APs) in a multiple basic service set identifications (BSSIDs) set and one or more APs of the AP MLD, wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link. The information further comprises a third set of bits, where the third set of bits is for station devices (STAs) that have individual BUs assigned to them. The first set of bits is for association identifications (AIDs) assigned to the plurality of APs in the multiple BSSIDs set. The first link and the second link are links between an AP MLD and a second MLD.

At block 904, the device may cause to send a beacon frame comprising the TIM element to one or more station devices (STAs). The TIM is encoded in the beacon frame, wherein the beacon frame is sent at a target beacon transmission time (TBTT). The beacon frame is sent on behalf of other APs in the plurality of APs in the multiple BSSIDs set. A BSSID-implemented value is set to 1 to indicate that multiple BSSID set is used. The BSSID-implemented value is set to 0 to indicate that multiple BSSID set is not used.

It is understood that the above descriptions are for purposes of illustration and are not meant to be limiting.

FIG. 10 shows a functional diagram of an exemplary communication station 1000, in accordance with one or more example embodiments of the present disclosure. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in the above figures, diagrams, and flows.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices, and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” may also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a group addressed BUs device 1119, a network interface device/transceiver 1120 coupled to antenna(s) 1130, and one or more sensors 1128, such as a global positioning system (GPS) sensor, a compass, an accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1102 for generation and processing of the baseband signals and for controlling operations of the main memory 1104, the storage device 1116, and/or the group addressed BUs device 1119. The baseband processor may be provided on a single radio card, a single chip, or an integrated circuit (IC).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The group addressed BUs device 1119 may carry out or perform any of the operations and processes (e.g., process 900) described and shown above.

It is understood that the above are only a subset of what the group addressed BUs device 1119 may be configured to perform and that other functions included throughout this disclosure may also be performed by the group addressed BUs device 1119.

While the machine-readable medium 1122 is illustrated as a single medium, the term “machine-readable medium” may include a single medium or multiple media (e.g., a centralized or distributed database, and/or associated caches and servers) configured to store one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-FIR, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” may be taken to include any intangible medium that is capable of storing, encoding, or carrying instructions for execution by the machine 1100 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

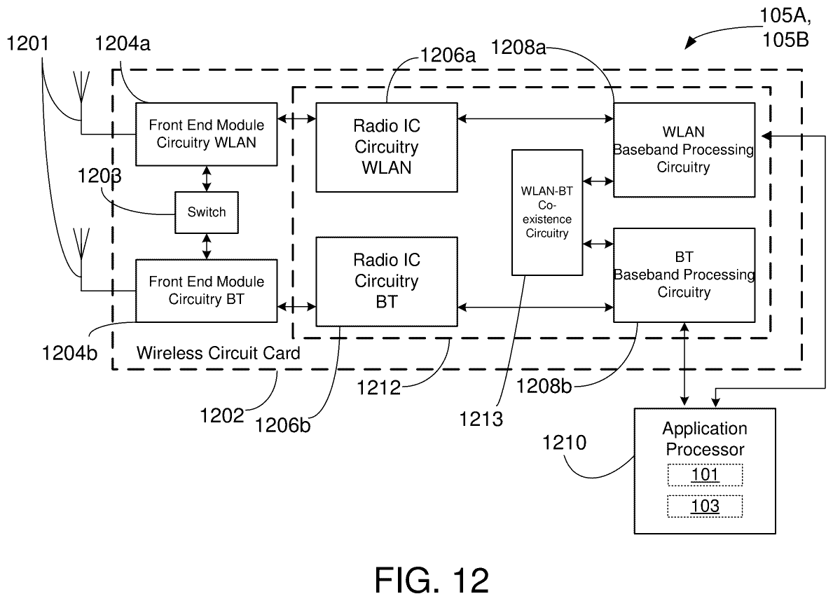

FIG. 12 is a block diagram of a radio architecture 105A, 105B in accordance with some embodiments that may be implemented in any one of the example APs 102 and/or the example user device(s) 120 of FIG. 1. Radio architecture 105A, 105B may include radio front-end module (FEM) circuitry 1204a-b, radio IC circuitry 1206a-b and baseband processing circuitry 1208a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1204a-b may include a WLAN or Wi-Fi FEM circuitry 1204a and a Bluetooth (BT) FEM circuitry 1204b. The WLAN FEM circuitry 1204a may include a receive signal path comprising circuitry configured to operate on WLAN RF signals received from one or more antennas 1201, to amplify the received signals and to provide the amplified versions of the received signals to the WLAN radio IC circuitry 1206a for further processing. The BT FEM circuitry 1204b may include a receive signal path which may include circuitry configured to operate on BT RF signals received from one or more antennas 1201, to amplify the received signals and to provide the amplified versions of the received signals to the BT radio IC circuitry 1206b for further processing. FEM circuitry 1204a may also include a transmit signal path which may include circuitry configured to amplify WLAN signals provided by the radio IC circuitry 1206a for wireless transmission by one or more of the antennas 1201. In addition, FEM circuitry 1204b may also include a transmit signal path which may include circuitry configured to amplify BT signals provided by the radio IC circuitry 1206b for wireless transmission by the one or more antennas. In the embodiment of FIG. 12, although FEM 1204a and FEM 1204b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1206a-b as shown may include WLAN radio IC circuitry 1206a and BT radio IC circuitry 1206b. The WLAN radio IC circuitry 1206a may include a receive signal path which may include circuitry to down-convert WLAN RF signals received from the FEM circuitry 1204a and provide baseband signals to WLAN baseband processing circuitry 1208a. BT radio IC circuitry 1206b may in turn include a receive signal path which may include circuitry to down-convert BT RF signals received from the FEM circuitry 1204b and provide baseband signals to BT baseband processing circuitry 1208b. WLAN radio IC circuitry 1206a may also include a transmit signal path which may include circuitry to up-convert WLAN baseband signals provided by the WLAN baseband processing circuitry 1208a and provide WLAN RF output signals to the FEM circuitry 1204a for subsequent wireless transmission by the one or more antennas 1201. BT radio IC circuitry 1206b may also include a transmit signal path which may include circuitry to up-convert BT baseband signals provided by the BT baseband processing circuitry 1208b and provide BT RF output signals to the FEM circuitry 1204b for subsequent wireless transmission by the one or more antennas 1201. In the embodiment of FIG. 12, although radio IC circuitries 1206a and 1206b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1208a-b may include a WLAN baseband processing circuitry 1208a and a BT baseband processing circuitry 1208b. The WLAN baseband processing circuitry 1208a may include a memory, such as, for example, a set of RAM arrays in a Fast Fourier Transform or Inverse Fast Fourier Transform block (not shown) of the WLAN baseband processing circuitry 1208a. Each of the WLAN baseband circuitry 1208a and the BT baseband circuitry 1208b may further include one or more processors and control logic to process the signals received from the corresponding WLAN or BT receive signal path of the radio IC circuitry 1206a-b, and to also generate corresponding WLAN or BT baseband signals for the transmit signal path of the radio IC circuitry 1206a-b. Each of the baseband processing circuitries 1208a and 1208b may further include physical layer (PHY) and medium access control layer (MAC) circuitry, and may further interface with a device for generation and processing of the baseband signals and for controlling operations of the radio IC circuitry 1206a-b.

Referring still to FIG. 12, according to the shown embodiment, WLAN-BT coexistence circuitry 1213 may include logic providing an interface between the WLAN baseband circuitry 1208a and the BT baseband circuitry 1208b to enable use cases requiring WLAN and BT coexistence. In addition, a switch 1203 may be provided between the WLAN FEM circuitry 1204a and the BT FEM circuitry 1204b to allow switching between the WLAN and BT radios according to application needs. In addition, although the antennas 1201 are depicted as being respectively connected to the WLAN FEM circuitry 1204a and the BT FEM circuitry 1204b, embodiments include within their scope the sharing of one or more antennas as between the WLAN and BT FEMs, or the provision of more than one antenna connected to each of FEM 1204a or 1204b.

In some embodiments, the front-end module circuitry 1204a-b, the radio IC circuitry 1206a-b, and baseband processing circuitry 1208a-b may be provided on a single radio card, such as wireless radio card 1202. In some other embodiments, the one or more antennas 1201, the FEM circuitry 1204a-b and the radio IC circuitry 1206a-b may be provided on a single radio card. In some other embodiments, the radio IC circuitry 1206a-b and the baseband processing circuitry 1208a-b may be provided on a single chip or integrated circuit (IC), such as IC 1212.

In some embodiments, the wireless radio card 1202 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1208b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHZ, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

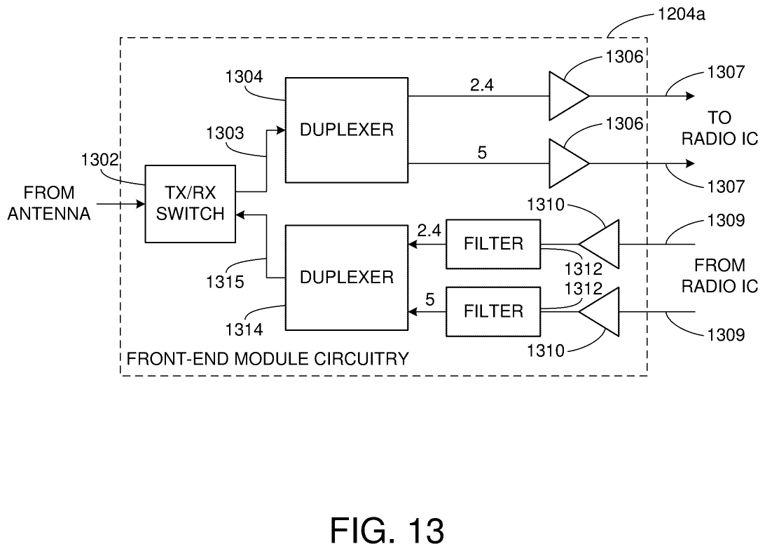

FIG. 13 illustrates WLAN FEM circuitry 1204a in accordance with some embodiments. Although the example of FIG. 13 is described in conjunction with the WLAN FEM circuitry 1204a, the example of FIG. 13 may be described in conjunction with the example BT FEM circuitry 1204b (FIG. 12), although other circuitry configurations may also be suitable.

In some embodiments, the FEM circuitry 1204a may include a TX/RX switch 1302 to switch between transmit mode and receive mode operation. The FEM circuitry 1204a may include a receive signal path and a transmit signal path. The receive signal path of the FEM circuitry 1204a may include a low-noise amplifier (LNA) 1306 to amplify received RF signals 1303 and provide the amplified received RF signals 1307 as an output (e.g., to the radio IC circuitry 1206a-b (FIG. 12)). The transmit signal path of the circuitry 1204a may include a power amplifier (PA) to amplify input RF signals 1309 (e.g., provided by the radio IC circuitry 1206a-b), and one or more filters 1312, such as band-pass filters (BPFs), low-pass filters (LPFs) or other types of filters, to generate RF signals 1315 for subsequent transmission (e.g., by one or more of the antennas 1201 (FIG. 12)) via an example duplexer 1314.

In some dual-mode embodiments for Wi-Fi communication, the FEM circuitry 1204a may be configured to operate in either the 2.4 GHz frequency spectrum or the 5 GHz frequency spectrum. In these embodiments, the receive signal path of the FEM circuitry 1204a may include a receive signal path duplexer 1304 to separate the signals from each spectrum as well as provide a separate LNA 1306 for each spectrum as shown. In these embodiments, the transmit signal path of the FEM circuitry 1204a may also include a power amplifier 1310 and a filter 1312, such as a BPF, an LPF or another type of filter for each frequency spectrum and a transmit signal path duplexer 1304 to provide the signals of one of the different spectrums onto a single transmit path for subsequent transmission by the one or more of the antennas 1201 (FIG. 12). In some embodiments, BT communications may utilize the 2.4 GHz signal paths and may utilize the same FEM circuitry 1204a as the one used for WLAN communications.

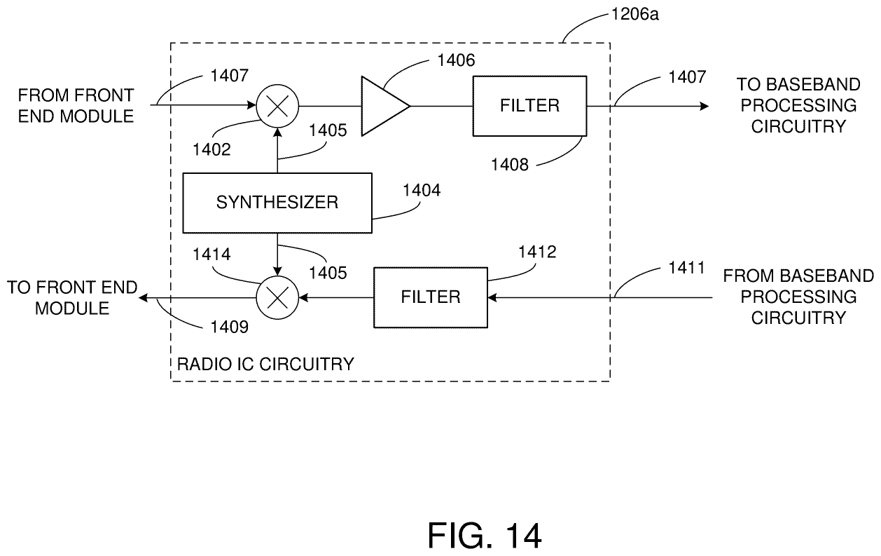

FIG. 14 illustrates radio IC circuitry 1206a in accordance with some embodiments. The radio IC circuitry 1206a is one example of circuitry that may be suitable for use as the WLAN or BT radio IC circuitry 1206a/1206b (FIG. 12), although other circuitry configurations may also be suitable. Alternatively, the example of FIG. 14 may be described in conjunction with the example BT radio IC circuitry 1206b.

In some embodiments, the radio IC circuitry 1206a may include a receive signal path and a transmit signal path. The receive signal path of the radio IC circuitry 1206a may include at least mixer circuitry 1402, such as, for example, down-conversion mixer circuitry, amplifier circuitry 1406 and filter circuitry 1408. The transmit signal path of the radio IC circuitry 1206a may include at least filter circuitry 1412 and mixer circuitry 1414, such as, for example, up-conversion mixer circuitry. Radio IC circuitry 1206a may also include synthesizer circuitry 1404 for synthesizing a frequency 1405 for use by the mixer circuitry 1402 and the mixer circuitry 1414. The mixer circuitry 1402 and/or 1414 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 14 illustrates only a simplified version of a radio IC circuitry, and may include, although not shown, embodiments where each of the depicted circuitries may include more than one component. For instance, mixer circuitry 1414 may each include one or more mixers, and filter circuitries 1408 and/or 1412 may each include one or more filters, such as one or more BPFs and/or LPFs according to application needs. For example, when mixer circuitries are of the direct-conversion type, they may each include two or more mixers.

In some embodiments, mixer circuitry 1402 may be configured to down-convert RF signals 1307 received from the FEM circuitry 1204a-b (FIG. 12) based on the synthesized frequency 1405 provided by synthesizer circuitry 1404. The amplifier circuitry 1406 may be configured to amplify the down-converted signals and the filter circuitry 1408 may include an LPF configured to remove unwanted signals from the down-converted signals to generate output baseband signals 1407. Output baseband signals 1407 may be provided to the baseband processing circuitry 1208a-b (FIG. 12) for further processing. In some embodiments, the output baseband signals 1407 may be zero-frequency baseband signals, although this is not a requirement. In some embodiments, mixer circuitry 1402 may comprise passive mixers, although the scope of the embodiments is not limited in this respect.

In some embodiments, the mixer circuitry 1414 may be configured to up-convert input baseband signals 1411 based on the synthesized frequency 1405 provided by the synthesizer circuitry 1404 to generate RF output signals 1309 for the FEM circuitry 1204a-b. The baseband signals 1411 may be provided by the baseband processing circuitry 1208a-b and may be filtered by filter circuitry 1412. The filter circuitry 1412 may include an LPF or a BPF, although the scope of the embodiments is not limited in this respect.

In some embodiments, the mixer circuitry 1402 and the mixer circuitry 1414 may each include two or more mixers and may be arranged for quadrature down-conversion and/or up-conversion respectively with the help of synthesizer 1404. In some embodiments, the mixer circuitry 1402 and the mixer circuitry 1414 may each include two or more mixers each configured for image rejection (e.g., Hartley image rejection). In some embodiments, the mixer circuitry 1402 and the mixer circuitry 1414 may be arranged for direct down-conversion and/or direct up-conversion, respectively. In some embodiments, the mixer circuitry 1402 and the mixer circuitry 1414 may be configured for super-heterodyne operation, although this is not a requirement.

Mixer circuitry 1402 may comprise, according to one embodiment: quadrature passive mixers (e.g., for the in-phase (I) and quadrature phase (Q) paths). In such an embodiment, RF input signal 1307 from FIG. 14 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1405 of synthesizer 1404 (FIG. 14). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1307 (FIG. 13) may comprise a balanced signal, although the scope of the embodiments is not limited in this respect. The I and Q baseband output signals may be provided to low-noise amplifier, such as amplifier circuitry 1406 (FIG. 14) or to filter circuitry 1408 (FIG. 14).

In some embodiments, the output baseband signals 1407 and the input baseband signals 1411 may be analog baseband signals, although the scope of the embodiments is not limited in this respect. In some alternate embodiments, the output baseband signals 1407 and the input baseband signals 1411 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1404 may be a fractional-N synthesizer or a fractional N/N+1 synthesizer, although the scope of the embodiments is not limited in this respect as other types of frequency synthesizers may be suitable. For example, synthesizer circuitry 1404 may be a delta-sigma synthesizer, a frequency multiplier, or a synthesizer comprising a phase-locked loop with a frequency divider. According to some embodiments, the synthesizer circuitry 1404 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1404 may be provided by a voltage controlled oscillator (VCO), although that is not a requirement. A divider control input may further be provided by either the baseband processing circuitry 1208a-b (FIG. 12) depending on the desired output frequency 1405. In some embodiments, a divider control input (e.g., N) may be determined from a look-up table (e.g., within a Wi-Fi card) based on a channel number and a channel center frequency as determined or indicated by the example application processor 1210. The application processor 1210 may include, or otherwise be connected to, one of the example secure signal converter 101 or the example received signal converter 103 (e.g., depending on which device the example radio architecture is implemented in).

In some embodiments, synthesizer circuitry 1404 may be configured to generate a carrier frequency as the output frequency 1405, while in other embodiments, the output frequency 1405 may be a fraction of the carrier frequency (e.g., one-half the carrier frequency, one-third the carrier frequency). In some embodiments, the output frequency 1405 may be a LO frequency (fLO).

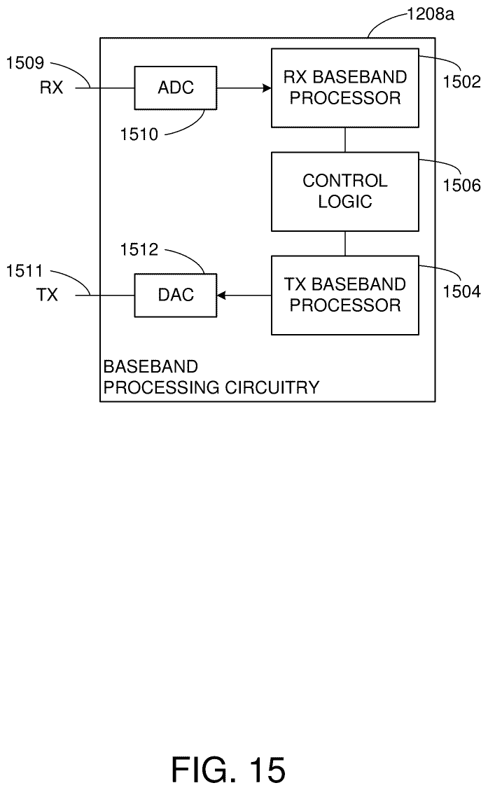

FIG. 15 illustrates a functional block diagram of baseband processing circuitry 1208a in accordance with some embodiments. The baseband processing circuitry 1208a is one example of circuitry that may be suitable for use as the baseband processing circuitry 1208a (FIG. 12), although other circuitry configurations may also be suitable. Alternatively, the example of FIG. 14 may be used to implement the example BT baseband processing circuitry 1208b of FIG. 12.

The baseband processing circuitry 1208a may include a receive baseband processor (RX BBP) 1502 for processing receive baseband signals 1409 provided by the radio IC circuitry 1206a-b (FIG. 12) and a transmit baseband processor (TX BBP) 1504 for generating transmit baseband signals 1411 for the radio IC circuitry 1206a-b. The baseband processing circuitry 1208a may also include control logic 1506 for coordinating the operations of the baseband processing circuitry 1208a.

In some embodiments (e.g., when analog baseband signals are exchanged between the baseband processing circuitry 1208a-b and the radio IC circuitry 1206a-b), the baseband processing circuitry 1208a may include ADC 1510 to convert analog baseband signals 1509 received from the radio IC circuitry 1206a-b to digital baseband signals for processing by the RX BBP 1502. In these embodiments, the baseband processing circuitry 1208a may also include DAC 1512 to convert digital baseband signals from the TX BBP 1504 to analog baseband signals 1511.

In some embodiments that communicate OFDM signals or OFDMA signals, such as through baseband processor 1208a, the transmit baseband processor 1504 may be configured to generate OFDM or OFDMA signals as appropriate for transmission by performing an inverse fast Fourier transform (IFFT). The receive baseband processor 1502 may be configured to process received OFDM signals or OFDMA signals by performing an FFT. In some embodiments, the receive baseband processor 1502 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 12, in some embodiments, the antennas 1201 (FIG. 12) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1201 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: encode a traffic indication map (TIM) element with information associated with a plurality of access points (APs) in a multiple basic service set identifications (BSSIDs) set and one or more APs of the AP MLD, wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link; and cause to send a beacon frame comprising the TIM element to one or more station devices (STAs).

Example 2 may include the device of example 1 and/or some other example herein, wherein the information further comprises a third set of bits, where the third set of bits may be for station devices (STAs) that have individual BUs assigned to them.

Example 3 may include the device of example 1 and/or some other example herein, wherein the first set of bits may be for association identifications (AIDs) assigned to the plurality of APs in the multiple BSSIDs set.

Example 4 may include the device of example 1 and/or some other example herein, wherein the first link and the second link are links between an AP MLD and a second MLD.

Example 5 may include the device of example 1 and/or some other example herein, wherein the TIM may be encoded in a beacon frame.

Example 6 may include the device of example 1 and/or some other example herein, wherein the beacon frame may be sent on behalf of other APs in the plurality of APs in the multiple BSSIDs set.

Example 7 may include the device of example 1 and/or some other example herein, wherein a BSSID-implemented value may be set to 1 to indicate that multiple BSSID set may be used.

Example 8 may include the device of example 7 and/or some other example herein, wherein a BSSID-implemented value may be set to 0 to indicate that multiple BSSID set may be not used.

Example 9 may include the device of example 1 and/or some other example herein, further comprising a transceiver configured to transmit and receive wireless signals.

Example 10 may include the device of example 9 and/or some other example herein, further comprising an antenna coupled to the transceiver to cause to send the beacon frame.

Example 11 may include a non-transitory computer-readable medium storing computer-executable instructions which when executed by one or more processors result in performing operations comprising: encoding a traffic indication map (TIM) element with information associated with a plurality of access points (APs) in a multiple basic service set identifications (BSSIDs) set and one or more APs of the AP MLD, wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link; and causing to send a beacon frame comprising the TIM element to one or more station devices (STAs).

Example 12 may include the non-transitory computer-readable medium of example 11 and/or some other example herein, wherein the information further comprises a third set of bits, where the third set of bits may be for station devices (STAs) that have individual BUs assigned to them.

Example 13 may include the non-transitory computer-readable medium of example 11 and/or some other example herein, wherein the first set of bits may be for association identifications (AIDs) assigned to the plurality of APs in the multiple BSSIDs set.

Example 14 may include the non-transitory computer-readable medium of example 11 and/or some other example herein, wherein the first link and the second link are links between an AP MLD and a second MLD.

Example 15 may include the non-transitory computer-readable medium of example 11 and/or some other example herein, wherein the TIM may be encoded in a beacon frame.

Example 16 may include the non-transitory computer-readable medium of example 11 and/or some other example herein, wherein the beacon frame may be sent on behalf of other APs in the plurality of APs in the multiple BSSIDs set.

Example 17 may include the non-transitory computer-readable medium of example 11 and/or some other example herein, wherein a BSSID-implemented value may be set to 1 to indicate that multiple BSSID set may be used.

Example 18 may include the non-transitory computer-readable medium of example 17 and/or some other example herein, wherein a BSSID-implemented value may be set to 0 to indicate that multiple BSSID set may be not used.

Example 19 may include a method comprising: encoding a traffic indication map (TIM) element with information associated with a plurality of access points (APs) in a multiple basic service set identifications (BSSIDs) set and one or more APs of the AP MLD, wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link; and causing to send a beacon frame comprising the TIM element to one or more station devices (STAs).

Example 20 may include the method of example 19 and/or some other example herein, wherein the information further comprises a third set of bits, where the third set of bits may be for station devices (STAs) that have individual BUs assigned to them.

Example 21 may include the method of example 19 and/or some other example herein, wherein the first set of bits may be for association identifications (AIDs) assigned to the plurality of APs in the multiple BSSIDs set.

Example 22 may include the method of example 19 and/or some other example herein, wherein the first link and the second link are links between an AP MLD and a second MLD.

Example 23 may include the method of example 19 and/or some other example herein, wherein the TIM may be encoded in a beacon frame.

Example 24 may include the method of example 19 and/or some other example herein, wherein the beacon frame may be sent on behalf of other APs in the plurality of APs in the multiple BSSIDs set.

Example 25 may include the method of example 19 and/or some other example herein, wherein a BSSID-implemented value may be set to 1 to indicate that multiple BSSID set may be used.

Example 26 may include the method of example 25 and/or some other example herein, wherein a BSSID-implemented value may be set to 0 to indicate that multiple BSSID set may be not used.

Example 27 may include an apparatus comprising means for: encoding a traffic indication map (TIM) element with information associated with a plurality of access points (APs) in a multiple basic service set identifications (BSSIDs) set and one or more APs of the AP MLD, wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link; and causing to send a beacon frame comprising the TIM element to one or more station devices (STAs).

Example 28 may include the apparatus of example 27 and/or some other example herein, wherein the information further comprises a third set of bits, where the third set of bits may be for station devices (STAs) that have individual BUs assigned to them.

Example 29 may include the apparatus of example 27 and/or some other example herein, wherein the first set of bits may be for association identifications (AIDs) assigned to the plurality of APs in the multiple BSSIDs set.

Example 30 may include the apparatus of example 27 and/or some other example herein, wherein the first link and the second link are links between an AP MLD and a second MLD.

Example 31 may include the apparatus of example 27 and/or some other example herein, wherein the TIM may be encoded in a beacon frame.

Example 32 may include the apparatus of example 31 and/or some other example herein, wherein the beacon frame may be sent on behalf of other APs in the plurality of APs in the multiple BSSIDs set.

Example 33 may include the apparatus of example 27 and/or some other example herein, wherein a BSSID-implemented value may be set to 1 to indicate that multiple BSSID set may be used.

Example 34 may include the apparatus of example 33 and/or some other example herein, wherein a BSSID-implemented value may be set to 0 to indicate that multiple BSSID set may be not used. Example 35 may include one or more non-transitory computer-readable media comprising instructions to cause an electronic device, upon execution of the instructions by one or more processors of the electronic device, to perform one or more elements of a method described in or related to any of examples 1-34, or any other method or process described herein.

Example 36 may include an apparatus comprising logic, modules, and/or circuitry to perform one or more elements of a method described in or related to any of examples 1-34, or any other method or process described herein.

Example 37 may include a method, technique, or process as described in or related to any of examples 1-34, or portions or parts thereof.

Example 38 may include an apparatus comprising: one or more processors and one or more computer readable media comprising instructions that, when executed by the one or more processors, cause the one or more processors to perform the method, techniques, or process as described in or related to any of examples 1-34, or portions thereof.

Example 39 may include a method of communicating in a wireless network as shown and described herein.

Example 40 may include a system for providing wireless communication as shown and described herein.

Example 41 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims z chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device for an access point (AP) multi-link device (MLD), the device comprising processing circuitry coupled to storage, the processing circuitry configured to:
encode a traffic indication map (TIM) element with information associated with a plurality of access points (APs) in a multiple basic service set identifications (BSSIDs) set and one or more APs of the AP MLD,
wherein the information comprises a first set of bits, where a first bit of the first set indicates group addressed bufferable units (BUs) of a first transmitted BSSID AP of the first set on a first link, where a second bit of the first set indicates group addressed BUs for a first non-transmitted BSSID AP on the first link, and
wherein the information further comprises a second set of bits, where a first bit of the second set indicates group addressed BUs of a second transmitted BSSID AP of the second set on a second link, where a second bit of the second set indicates group addressed BUs for a second non-transmitted BSSID AP on the second link; and
cause to send a beacon frame comprising the TIM element to one or more station devices (STAs).
